(19) United States
(12) Patent Application Publication
(10) Pub. No.: US 2025/0262739 A1
(43) Pub. Date: Aug. 21, 2025

(54) All-in-One Tool Accessory for Bicycles and all Small Personal Wheeled Vehicles

(71) Applicants: Randolph Kemps, Redwood City, CA (US); Hermann Kronbauer, Redwood City, CA (US)

(72) Inventors: Randolph Kemps, Redwood City, CA (US); Hermann Kronbauer, Redwood City, CA (US)

(21) Appl. No.: 18/583,532

(22) Filed: Feb. 21, 2024

(51) Int. Cl. B25F 1/02

(52) U.S. Cl. CPC B25F 1/02

(57) ABSTRACT

Disclosed in the present invention is an all-in-one tool accessory for bicycles and all small personal wheeled vehicles as a combination of tools and electronics that can be used for regular maintenance of these devices to improve performance and maximize safety. The invention discloses a combination tool for personal, small, wheeled vehicles such as bicycles, mountain bicycles, tandems, tricycles, and E-Bikes as well as similar types of vehicles with wheels, and/or without chains, brakes and pedals for outdoor use. The accessory can be used to repair tire and tube damage, fix broken chains, tighten screw connections that have become loose during use, adjust and readjust gear shifts, and to adjust brakes. There is additional functionality with a LED light and the ability to control up to four (4) remote control devices.

### Technical Field of Invention

The present invention relates to mechanical and electronic tools, and more specifically, to an all-in-one tool accessory for bicycles and all small personal wheeled vehicles as a combination of tools and electronics that can be used for regular maintenance of these devices to improve performance and maximize safety.

### BACKGROUND OF THE INVENTION

Whether enthusiasts or professionals, riders of small, personal, wheeled vehicles need to prepare for emergencies with malfunctions or mishaps. Regular maintenance improves performance, minimizes failures and improves safety.

Currently, this requires the rider to carry a variety of tools to cover all eventualities: punctures, jumping gears, rubbing brakes, broken cleats or pedals, snapped chains and more depending on the vehicle. This means a bulky and cumbersome set of tools as the nature of the problem cannot be known in advance.

There is no accessory on the market today that allows general maintenance, easy access through remote controls and a quick solution to many of these emergency issues in one compact and lightweight accessory.

### OBJECTS OF THE INVENTION

The main object of the present invention is to provide an all-in-one tool accessory for bicycles and all small personal wheeled vehicles.

Another object of the present invention is to avail safety features such as an avalanche transmitter and LED light make this a vital and unique accessory skiing and snowboarding.

The following summary is an explanation of some of the general inventive steps for the system, method, architecture and container in the description.

### SUMMARY OF THE INVENTION

The present invention describes an all-in-one tool accessory for bicycles and all small personal wheeled vehicles as a combination of tools and electronics that can be used for regular maintenance of these devices to improve performance and maximize safety.

In another embodiment, the invention teaches about an all-in-one accessory for small wheeled vehicles is a tool for all small personal-wheeled vehicles such as bicycles, mountain bicycles, tandems, tricycles, and E-Bikes as well as similar types of vehicles with wheels, and/or without chains, brakes and pedals to maintain and quickly fix problems during an emergency. This accessory is a combination of tools and electronics. It can also be used for regular maintenance of these devices to improve performance and maximize safety.

The all-in-one accessory for small personal wheeled vehicles eliminates the need for several tools to repair many of the common issues riders face on the road. In a compact and lightweight accessory, many of the tools required to fix tubes, chains, or other problems described above can be repaired quickly and easily. This compact tool is also ideal for the maintenance and adjustment of small, personal wheeled vehicles.

The above summary is not an extensive overview of the invention and does not intend to limit the scope beyond what is described and claimed as a summary.

### BRIEF DESCRIPTION OF DRAWINGS

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 is a representation of an all-in-one tool accessory for bicycles and all small personal wheeled vehicles showing shells as described in the present invention.

FIG. 2 is a representation of an all-in-one tool accessory for bicycles and all small personal wheeled vehicles showing a remote control as described in the present invention.

FIG. 3 is a representation of an all-in-one tool accessory for bicycles and all small personal wheeled vehicles indicating the location of a wrench as described in the present invention.

FIG. 4 is a representation of an all-in-one tool accessory for bicycles and all small personal wheeled vehicles showing a bit extension as described in the present invention.

FIG. 5 is a representation of an all-in-one tool accessory for bicycles and all small personal wheeled vehicles illustrating the shells as described in the present invention.

The above figures describe the components in the accessory, their layout, and their location. The drawings identify the various tools and also the location of each tool. These drawings depict the complete standard accessory location sections. Customization of the tool set to an equipment specific model is possible.

### DETAILED DESCRIPTION OF INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In this description, the terms “comprising,” “including,” “containing,” “characterized by,” and grammatical equivalents thereof are inclusive or open-ended terms that do not exclude additional, un-recited elements or method acts, but also include the more restrictive terms “consisting of” and “consisting essentially of”′ and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

The singular forms “a,” “an,” and “the” are intended to include the plural forms as well, unless the context clearly indicates otherwise.

The term “and/or” includes any and all combinations of one or more of the associated listed items. As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

In one general embodiment, the present invention provides an all-in-one tool accessory for bicycles and all small personal wheeled vehicles as a combination of tools and electronics that can be used for regular maintenance of these devices to improve performance and maximize safety.

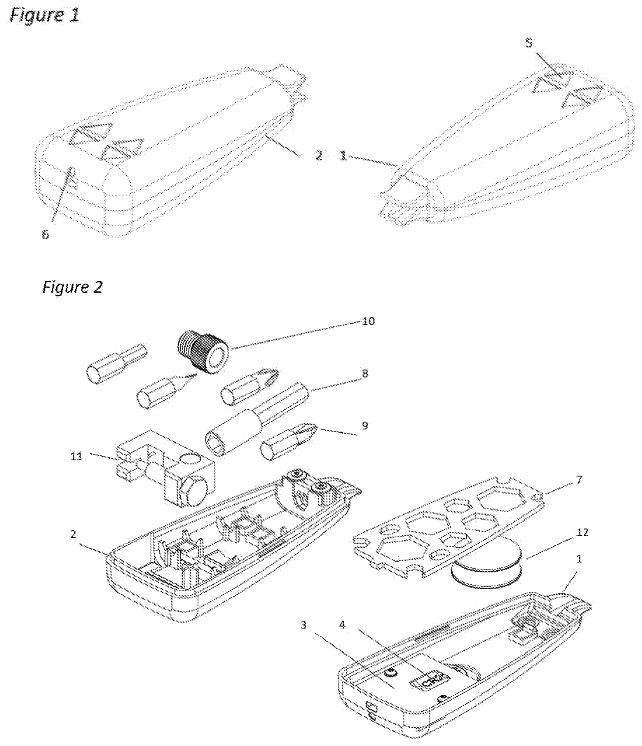

In FIG. 1, the invention illustrates an all-in-one tool accessory for bicycles and all small personal wheeled vehicles showing shell 1 (1) attached to shell 2 (2) having buttons (5) and LED flashlight function (6). In FIG. 2, the invention illustrates an all-in-one tool accessory for bicycles and all small personal wheeled vehicles showing a remote control (3) and battery (4) in shell 1 (1). Also shown are shell wrench (7), and self-adhesive patches (12). It also demonstrates the location of a screwdriver bits (9), bit extension (8), valve adapter (10) and chain breaker (11).

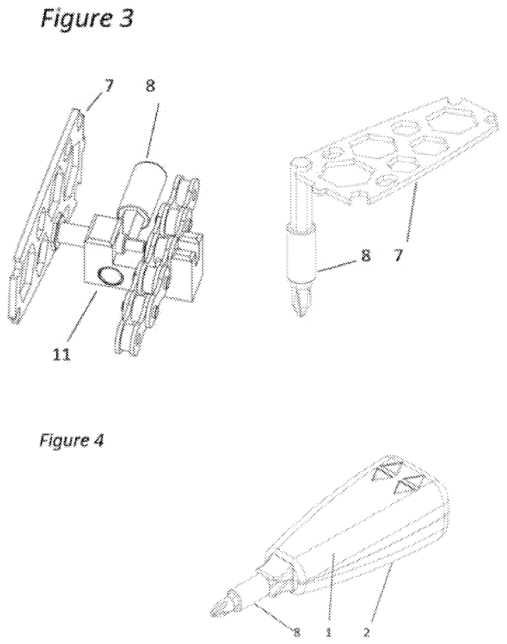

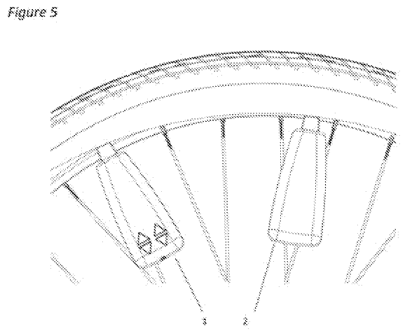

In FIG. 3, the invention illustrates an all-in-one tool accessory for bicycles and all small personal wheeled vehicles indicating the location of a wrench (7) attached to the shell 1 (1), bit extension (8). In FIG. 4, the invention illustrates an all-in-one tool accessory for bicycles and all small personal wheeled vehicles showing a bit extension (8), shell 1 (1) and shell 2 (2). In FIG. 5, the invention illustrates an all-in-one tool accessory for bicycles and all small personal wheeled vehicles illustrating the shell 1 (1) and shell 2 (2).

In a similar embodiment, the invention avails an all-in-one accessory for small personal wheeled vehicles that is designed to eliminate the need for several tools to repair many of the common issues riders face on the road. In a compact and lightweight accessory, many of the tools required to fix tubes, chains, or other problems described above can be repaired quickly and easily. This compact tool is also ideal for the maintenance and adjustment of small, personal wheeled vehicles.

In another embodiment, the invention teaches about an all-in-one accessory for small wheeled vehicles is a tool for all small personal-wheeled vehicles such as bicycles, mountain bicycles, tandems, tricycles, and e-bikes as well as similar types of vehicles with wheels, and/or without chains, brakes and pedals to maintain and quickly fix problems during an emergency. This accessory is a combination of tools and electronics. It can also be used for regular maintenance of these devices to improve performance and maximize safety.

In another embodiment, the invention discloses an all-in-one accessory for small personal wheeled vehicles is a multifunction device that is compact and lightweight for use with bicycles, mountain bicycles, tandems, tricycles, and e-bikes as well as similar types of vehicles with wheels, and/or without chains, brakes and pedals containing a comprehensive set of tools for a rider, as well as a remote control capability and a flashlight. This all in one accessory provides all the tools necessary to easily and quickly adjust settings with a wrench and screwdriver bits as well as the tools and items required to repair punctures, and chains and to make adjustments and repairs on the road in an emergency. It also contains an LED flashlight (6) and electronics enabling remote operation of up to 4 devices such as a garage, gate, anti-theft device etc.

In another embodiment, the invention discloses a tool that allows the rider to be prepared for most eventualities on the road. This valuable accessory avoids the need for the rider to carry a variety of tools that may be bulky and heavier. The mechanical functional parts include screwdriver bits (9), bit extensions (8), a wrench (7) with the most important hexagonal openings, and four open-end wrench openings for tightening spoke nuts, as well as a valve adapter (10) (bicycle to car valve), self-adhesive round patches and oval patches for inner tube repair, and adhesive plaster (12) for smaller injuries. These are all accommodated in a plastic housing made of two half-shells. The chain riveter is used to repair torn drive chains. Using the wrench (7) as a toggle handle and the bit extension (8) as a counter-hold ensures that the chain can be repaired easily and safely as shown in FIG. 3.

Additionally, an integrated adaptive remote control makes it unnecessary to take several remote controls such as for an anti-theft device, garden gate, and garage door. This reduces the ballast to a minimum by including the parts and functions that are really necessary for safety and independence. In addition, there is a flashlight function through an integrated LED (6).

In two housing shells, which serve as packaging and tire levers, there are one or more valve adapters (10), one or more screwdriver bits (9), a bit extension (8), and a wrench (7) (also double handle for bit extension and chain tool) with various hexagonal openings and four jaw openings for adjusting spoke nuts, a chain tool, and various self-adhesive patches (12). The remote control with the battery (4), the function keys, and the LED (6) with torch function are integrated into the housing shell as taught in FIG. 1.

During transportation, the two housing shells are secured by appropriately centering to each other and hook latches so that the contents cannot move or be lost and there is no risk of injury in the event of a fall.

Best Mode of Carrying out the Invention

At its best, the invention describes an all-in-one tool accessory for bicycles and all small personal wheeled vehicles, comprising a combination of tools and electronics that can be used for regular maintenance of these devices to improve performance and maximize safety; remote control (3); LED (6) with a flashlight; two housing shells, and a number of mechanical parts as in FIG. 1.

The remote control (3) is integrated into the all in one accessory for personal small wheeled vehicles housing, which can configure itself and manage four original remote controls. The LED (6) with a flashlight function is integrated into the housing. The two housing shells are firmly connected and can be separated by loosening fasteners or clamping elements.

The housing made of plastic or metal, or other suitable material consisting of housing shells (1) and (2), various tools, patches, a valve adapter (10), and a chain tool are mechanically held in position or loose.

The type and number of mechanical parts, screwdriver bits (9), bit extension (8), wrench (7), rubber patches (12), and valve adapter (10) can be customized as in FIG. 2.

The dimensions of the housing are not limited, so larger housing units would also be feasible to contain more components within the constraints of bulk and weight. The two housing shells (1) and (2) are used as tire levers. The marked area of the shell (tire lever) (2) is used to roughen the area for repairing the tube. Wherein when using the bit extension (8), key (7) is used as a toggle handle for securing or tightening and opening various screw connections.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments. Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention applies to mechanical and electronic tools. It brings to the market an all-in-one tool accessory for bicycles and all small personal wheeled vehicles as a combination of tools and electronics that can be used for regular maintenance of these devices to improve performance and maximize safety. The said accessory eliminates the need for several tools to repair many of the common issues riders face on the road. In a compact and lightweight accessory, many of the tools required to fix tubes, chains, or other problems described above can be repaired quickly and easily. This compact tool is also ideal for the maintenance and adjustment of small, personal wheeled vehicles.

What is claimed is:

1. An all-in-one tool accessory for bicycles and all small personal wheeled vehicles, comprising:
a. a combination of tools and electronics that can be used for regular maintenance of these devices to improve performance and maximize safety;
b. a remote control (3);
c. a LED (6) with a flashlight;
d. two housing shells, and
e. a number of mechanical parts.

2. The all-in-one tool accessory according to claim 1, wherein the remote control (3) is integrated into the all in one accessory for personal small wheeled vehicles housing, which can configure itself and manage four original remote controls.

3. The all-in-one tool accessory according to claim 1, wherein the LED (6) with a flashlight function is integrated into the housing.

4. The all-in-one tool accessory according to claim 1, wherein the two housing shells are firmly connected and can be separated by loosening fasteners or clamping elements.

5. The all-in-one tool accessory according to claim 1, wherein the housing made of plastic or metal, or other suitable material consisting of housing shells (1) and (2), various tools, patches, a valve adapter, and a chain tool are mechanically held in position or loose.

6. The all-in-one tool accessory according to claim 1, wherein the type and number of mechanical parts, screwdriver bits (9), bit extension (8), wrench (7), rubber patches (12), and valve adapter (10) can be customized.

7. The all-in-one tool accessory according to claim 1, wherein the dimensions of the housing are not limited, so larger housing units would also be feasible to contain more components within the constraints of bulk and weight.

8. The all-in-one tool accessory according to claim 1, wherein the two housing shells (1) and (2) are used as tire levers.

9. The all-in-one tool accessory according to claim 1, wherein the marked area of the shell (tire lever) (2) is used to roughen the area for repairing the tube.

10. The all-in-one tool accessory according to claim 1, wherein when using the bit extension (8), key (7) is used as a toggle handle for securing or tightening and opening various screw connections.

11. The all-in-one tool accessory according to claim 1, wherein when using the chain native (11) of the key (7) as a gag handle, the pressing of the chain bolt or the rivet of the chain facilitates and the bit extension (8) serves as a counter holder against the rotation of the chain.

12. The all-in-one tool accessory according to claim 1, wherein the internal layout and contents of the accessory can be adjusted to be specific to the vehicle type.
